(19) United States
(12) Patent Application Publication
(10) Pub. No.: US 2005/0019211 A1
(43) Pub. Date: Jan. 27, 2005

(54) Test strip for examination liquid test sample

(76) Inventor: Ching-Ho Lien, Taipei (TW)

Correspondence Address: PRO-TECHTOR INTERNATIONAL SERVICES, 20775 Norada Court, Saratoga, CA, 95070-3018, US

(21) Appl. No.: 10/627,319

(22) Filed: Jul. 24, 2003

(51) Int. Cl. G01N 31/22

(52) U.S. Cl. 422/56

(57) ABSTRACT

A test strip is constructed to include a substrate and a bio-carbon circuit pattern formed of two circuits and printed on the substrate, the circuits each having a front probe end spaced from each other by a test sample accumulation space in the substrate and adapted to contact the liquid test sample being dropped from the top side or guided from one lateral side of the substrate and to produce a reacted signal and then to transmit the reacted signal to the meter in which the test strip is inserted after contact of the front probe ends of the circuits with the applied liquid test sample.

### BACKGROUND OF THE INVENTION

1. Field of the Invention

The present invention relates to test strips for medical examination use and, more particularly, to such a test strip, which picks up the liquid test sample to be examined from one lateral side conveniently for accurate examination.

2. Description of the Related Art

A variety of test strips have been disclosed for use with different meters for examination the concentration of different substances in the urine, blood, or serum. During examination, the liquid test sample (urine, blood, or serum) is applied to the test strip, and then the test strip is inserted into the respective meter for analysis. Subject to the test sample application methods, regular test strips are divided into two types. According to the first type, the examiner needs to use a pipette or the like to pick up the test sample and then to drop the test sample to the test sample receiving area of the test strip from the top side. According to the second type, the examiner needs to use a puncher to punch a hole in the patient's thumb, for enabling the blood to flow out of the hole, and then the examiner has to attach the sideway entrance of the test strip to the hole in the patient's thumb to pick up the blood from the patient and to guide the blood to the test area in the test strip. The former type needs a pipette or the like to apply the test sample to the test strip. The latter enables the examiner to directly pick up the test sample from the punched area in the patient's thumb. However, if the examiner has no punch means to punch a hole in the patient's thumb for collecting the desired blood sample, the examination cannot be proceeded.

### SUMMARY OF THE INVENTION

The present invention has been accomplished under the circumstances in view. It is the main object of the present invention to provide a test strip, which eliminates the aforesaid drawbacks. It is another object of the present invention to provide a test strip, which enables the examiner to pick up the test sample directly from the patient through a direct contact, or through a pipette or the like by dropping.

According to one aspect of the present invention, the test strip comprises a narrow elongated strip of substrate insertable in a liquid test sample examining meter and adapted to carry the liquid test sample to be examined, and a bio-carbon circuit pattern printed on substrate. The circuit pattern comprises a first circuit and a second circuit adapted to contact the liquid test sample been applied to the substrate, to produce a reacted signal upon contact with the applied liquid test sample, and to transmit the reacted signal to the liquid test sample examining meter in which the test strip is inserted. According to another aspect of the present invention, the substrate has a test sample accumulation space adapted to accumulate the applied liquid test sample, and a protruding guide portion adapted to pick up the liquid test sample and to guide the applied liquid test sample to the probe ends of the first and second circuits.

### BRIEF DESCRIPTION OF THE DRAWINGS

FIG. 1 is a front plain view of a test strip according to a first embodiment of the present invention.

FIG. 2 is a front plain view of a test strip according to a second embodiment of the present invention.

FIG. 3 is a front plain view of a test strip according to a third embodiment of the present invention.

FIG. 4 is a front plain view of a test strip according to a fourth embodiment of the present invention.

### DETAILED DESCRIPTION OF THE PREFERRED EMBODIMENT

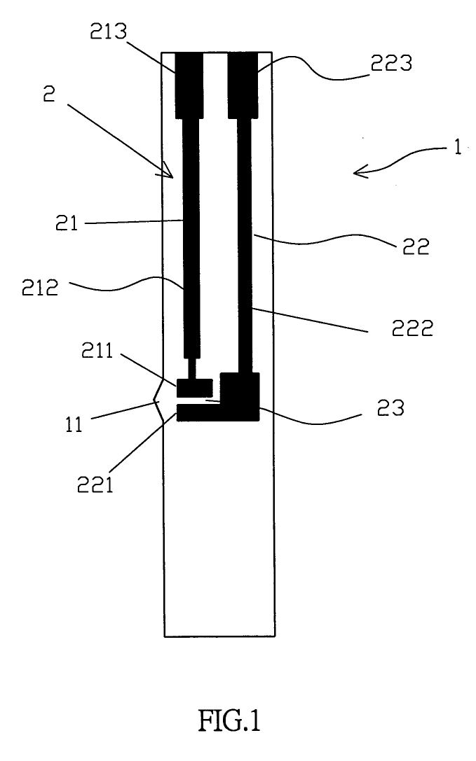

Referring to FIG.1, a test strip in accordance with the present invention is shown comprised of a narrow elongated strip of substrate 1, and a circuit pattern 2 formed in the substrate 1. When a liquid test sample (blood, serum, etc.) dropped to the circuit pattern 2 in the substrate 1 from the top side or guided to the circuit pattern 2 from one lateral side of the substrate 1, the substrate 1 is inserted into a meter (not shown), enabling the meter to examine the concentration of a particular substance in the applied liquid test sample.

The circuit pattern 2 is formed of bio-carbon and directly printed on the substrate 1, comprising a first circuit 21 and a second circuit 22. The first circuit 21 and the second circuit 22 each have a front probe end 211 or 221, a rear contact end 213 or 223, and an elongated transmission section 212 or 222 connected between the front probe end 211 or 221 and the rear contact end 213 or 223. The first and second circuits 21 and 22 are so arranged that a test sample accumulation space 23 is formed in the substrate 1 between the front probe ends 211 and 221 of the circuits 21 and 22 and adapted to receive the liquid test sample to be examined. Further, the substrate 2 has a protruding guide portion 11 corresponding to the test sample accumulation space 23 for guiding the applied liquid test sample into the test sample accumulation space 23. When the applied liquid test sample guided to the test sample accumulation space 23, the front probe ends 211 and 221 of the circuits 21 and 22 are induced to produce a reacted signal. The transmission sections 212 and 222 of the circuits 21 and 22 transmit the reacted signal from the front probe ends 211 and 221 to the rear contact ends 213 and 223 and then to respective contacts in the meter in which the test strip is inserted.

Referring to FIG. 1 again, when the applied liquid test sample guided to the test sample accumulation space 23, the applied liquid test sample immediately touches the front probe ends 211 and 221 of the circuits 21 and 22 and mixed with the enzyme in the test strip, thereby producing a reacted signal. When the user inserted the test strip in the meter, the transmission sections 212 and 222 of the circuits 21 and 22 immediately transmit the reacted signal to the internal circuit of the meter through the rear contact ends 213 and 223, enabling the meter to analyze the concentration of the assigned substance in the applied liquid test sample.

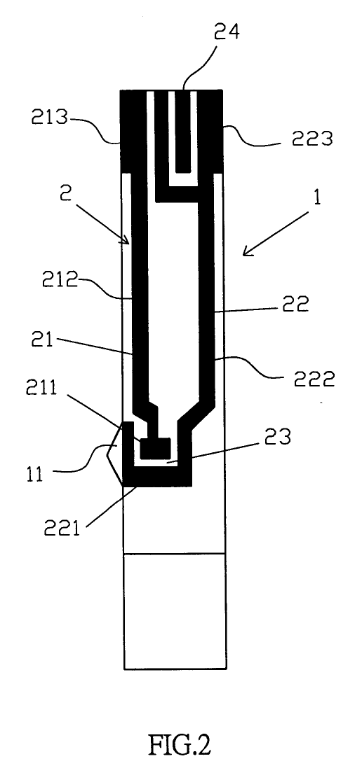

FIG. 2 shows an alternate form of the test strip according to the present invention. This embodiment is similar to the aforesaid first embodiment with the exception of the design of the second circuit 22. According to this embodiment, the second circuit 22 has its front probe end 221 extending transversely forwards and spaced from the bottom side of the front probe end 211 of the first circuit 21 at a distance, and then extending longitudinally upwards and spaced from the left side of the front probe end 211 of the first circuit 21 at a distance. Further, the second circuit 22 has a plurality of auxiliary rear contacts 24 respectively extended from the transmission section 22 for enabling the test strip to fit different contact positions in different models of meters.

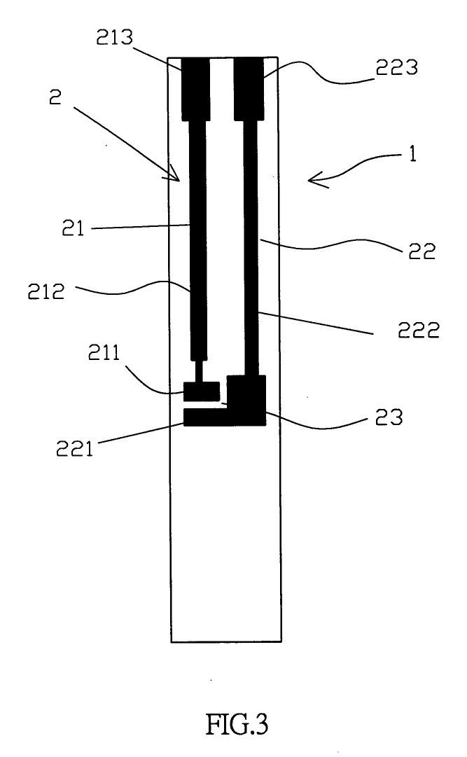

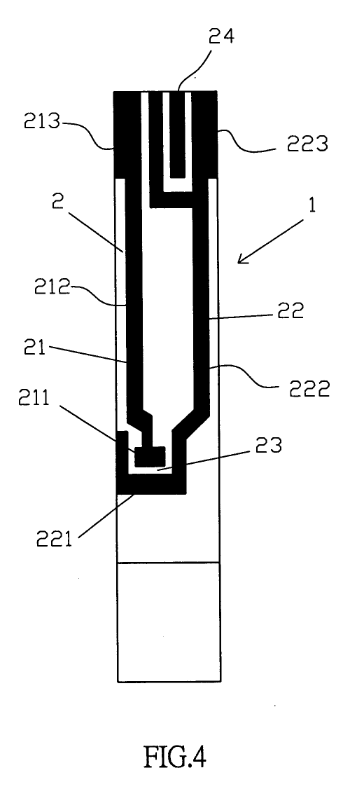

FIGS. 3 and 4 show still another two alternate forms of the test strip. These two embodiments are similar to the embodiments shown in FIGS. 1 and 2 respectively, however these two embodiments eliminate the aforesaid protruding guide portion 11 from the substrate 2.

A prototype of test strip for examining liquid test sample has been constructed with the features of FIGS. 1˜4. The test strip for examining liquid test sample functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A test strip adapted to receive a liquid test sample and insertable in ammeter for enabling the received liquid test sample to be analyzed by the meter, the test strip comprising:
a narrow elongated strip of substrate insertable in the meter and adapted to carry the liquid test sample to be examined; and
a circuit pattern formed in said strip of substrate, said circuit pattern comprising a first circuit and a second circuit adapted to contact the liquid test sample been applied to said strip of substrate, to produce a reacted signal upon contact with the liquid test sample been applied to said strip of substrate, and to transmit said reacted signal to the meter in which the test strip is inserted.

2. The test strip as claimed in claim 1, wherein said circuit pattern is formed of bio-carbon.

3. The test strip as claimed in claim 1, wherein said first circuit and said second circuit each comprise a front probe end adapted to contact the applied liquid test sample, a rear contact end adapted to contact a respective contact in the meter, and an elongated transmission section connected between said front probe end and said rear contact end; said strip of substrate comprises a test sample accumulation space defined between the front probe ends of said first and second circuits and adapted to accumulate the applied liquid test sample.

4. The test strip as claimed in claim 1, wherein said strip of substrate comprises a protruding guide portion adapted to pick up the liquid test sample to be examined and to guide the received liquid test sample to said test sample accumulation space.

5. The test strip as claimed in claim 1, wherein the front probe end of said second circuit is spaced from and extends around bottom and lateral sides of the front probe end of said first circuit.

6. The test strip as claimed in claim 1, wherein said circuit pattern further comprises a plurality of auxiliary contacts spaced between the rear contact end of said first circuit and the rear contact end of said second circuit and respectively connected to the transmission section of said second circuit.
